(19) United States
(12) Patent Application Publication
(10) Pub. No.: US 2008/0170317 A1
(43) Pub. Date: Jul. 17, 2008

(54) Inspection head used for magnetic disc inspecting apparatus

(75) Inventors: Masahiro Aizawa, Higashine-shi (JP); Takeshi Tokairin, Higashine-shi (JP); Jun Fujii, Higashine-shi (JP); Takako Yamauchi, Higashine-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/985,967

(22) Filed: Nov. 19, 2007

(30) Foreign Application Priority Data
Jan. 17, 2007 (JP) 2007-008591

(51) Int. Cl. G11B 20/18; B05D 3/06

(52) U.S. Cl. 360/31; 427/595

(57) ABSTRACT

An inspection head is used for an inspecting apparatus that inspects whether there is an abnormal projection on a disk surface having a first lubrication layer, and floats over the disk surface. The inspection head includes a floating surface covered with a second lubrication layer that is repellent to the first lubrication layer.

This application claims the right of a foreign priority based on Japanese Patent Application No. 2007-008591, filed on Jan. 17, 2007, which is hereby incorporated by reference herein in its entirety as if fully set forth herein.

### BACKGROUND OF THE INVENTION

The present invention relates generally to a magnetic disk inspecting apparatus, and more particularly to a glide inspection apparatus that inspects whether or not a disk to be mounted in a hard disk drive (“HDD”) can provides a given floating amount or height to a slider.

In the HDD, a head records information in and reproduces information from a disk while a slider mounted with the head floats over the disk. The airflow associated with disk rotations generates a floating force that floats the slider over the disk surface. A suspension supports the slider and applies an elastic force against the floating force of the slider. The HDD controls a floating amount of the slide through a balance between the floating force and the elastic force.

When the floating amount is too large, the head is too distant from the disk to record and reproduce information. When the floating amount is too small, the slider is likely to collide with the disk. Then, both or one of them can get damaged, and the collision would delete the data recorded in the disk. Since the floating amount becomes smaller to meet a requirement for the higher recording density of the disk, control over the floating amount is important in the current HDD.

When the disk surface has an abnormal projection, the slider collides with the projection and the floating control deteriorates. Therefore, a glide inspection apparatus has conventionally been proposed which detects an inferior disk having an abnormal projection on its disk surface. See Japanese Patent Application, Publication No. 2001-184632. The inferior disk detected by the glide inspection apparatus is removed from a candidate to be mounted into the HDD so as to secure the flatness of the disk surface and the stable floatation of the slider.

The glide inspection apparatus floats the inspection head over the disk surface as an inspection target, and inspects the floating state. When contaminants on the disk adhere to the inspection head and deteriorate the floating property of the slider in the inspections, the slider cannot properly inspect the next disk. In addition, a disk defect and a collision of the inspection head may cause the floating balance and absorption of the inspection head onto the disk. This absorption lasts between the inspection head and the disk until the end of the inspection. As a result, the inspection head may get damaged and the contaminants accumulate, increasing an exchange frequency of the inspection head.

### BRIEF SUMMARY OF THE INVENTION

The present invention is directed to an inspection head to which a contaminant is less likely to adhere.

An inspection head according to one embodiment of the present invention is used for an inspecting apparatus that inspects whether there is an abnormal projection on a disk surface having a first lubrication layer. The inspection head floats over the disk surface and includes a floating surface covered with a second lubrication layer that is repellent to the first lubrication layer. According to the slider, the second lubrication layer makes the slider's surface less likely to absorb a contaminant. Thus, even if the slider adheres to the disk surface it is likely to separate from it. For example, the first lubrication layer is made of tetraol, and the second lubrication layer is made of fomblin.

An inspecting apparatus that includes the above inspection head improves the inspection throughput with the reduced head exchange frequency.

A manufacturing method according to another aspect of the present invention for manufacturing an inspection head used for an inspecting apparatus that inspects whether there is an abnormal projection on a disk surface having a first lubrication layer, and the inspection head floating over the disk surface includes the steps of applying onto a floating plane of the inspection head a lubricant of a second lubrication layer that is repellent to the first lubrication layer, and irradiating ultraviolet light onto the lubricant and forming the second lubrication layer on the floating surface. This manufacturing method can form the second lubrication layer without thermally damaging an inspection sensor without baking.

The lubricant is made, for example, of a perfluoropolyether compound that dispenses with a hydroxyl group at a distal end.

The forming step preferably sets a film thickness of the second lubrication layer between 1.5 nm and 2.6 nm. This range is confirmed to provide an effect of improving the take off velocity (“TOV”).

Other objects and further features of the present invention will become readily apparent from the following description of the preferred embodiments with reference to accompanying drawings.

### BRIEF DESCRIPTION OF THE DRAWINGS

FIG. 1 is a schematic perspective view and partially enlarged sectional views of a glide inspecting apparatus and a slider according to the present invention.

FIG. 2A is a schematic plane view of the inspection head having a slider shown in FIG. 1. FIG. 2B is a schematic side view of the inspection head having the slider shown in FIG. 1. FIG. 2C is a schematic rear view of the inspection head having the slider shown in FIG. 1.

FIG. 3 is a graph showing a relationship between a TOV and a touch down velocity (“TDV”) of the slider shown in FIG. 1 and a conventional slider.

FIG. 4 is a graph showing a relationship between a pitch angle and a difference between a TOV and a TDV.

FIG. 5A is a graph showing a relationship between a film thickness of a lubrication layer of the slider shown in FIG. 1 and the TOV improvement amount. FIG. 5B is a graph showing a relationship between the film thickness of the lubrication layer of the slider shown in FIG. 1 and a contact angle to pure water. FIG. 5C is a graph showing a relationship between the film thickness of the lubrication layer of the slider shown in FIG. 1 and an bonding ratio (%).

FIG. 6A is a graph showing a relationship between a distance from a disk center and a sensor output when a conventional slider inspects a first disk surface with no abnormal projection. FIG. 6B is a graph showing a relationship between a distance from the center of the disk and the sensor output when the conventional slider inspects a tenth disk surface with no abnormal projection. FIG. 6C is a graph showing a relationship between a distance from the center of the disk and the sensor output when the conventional slider inspects a twelfth disk surface with no abnormal projection.

FIG. 7A is a graph showing a relationship between a distance from a disk center and a sensor output when the slider shown in FIG. 1 inspects a first disk surface with no abnormal projection. FIG. 7B is a graph showing a relationship between a distance from the center of the disk and the sensor output when the slider shown in FIG. 1 inspects a tenth disk surface with no abnormal projection. FIG. 7C is a graph showing a relationship between a distance from the center of the disk and the sensor output when the slider shown in FIG. 1 inspects a twelfth disk surface with no abnormal projection.

FIG. 8 is a flowchart for explaining a method for manufacturing a slider shown in FIG. 1.

### DETAILED DESCRIPTION OF THE PREFERRED EMBODIMENTS

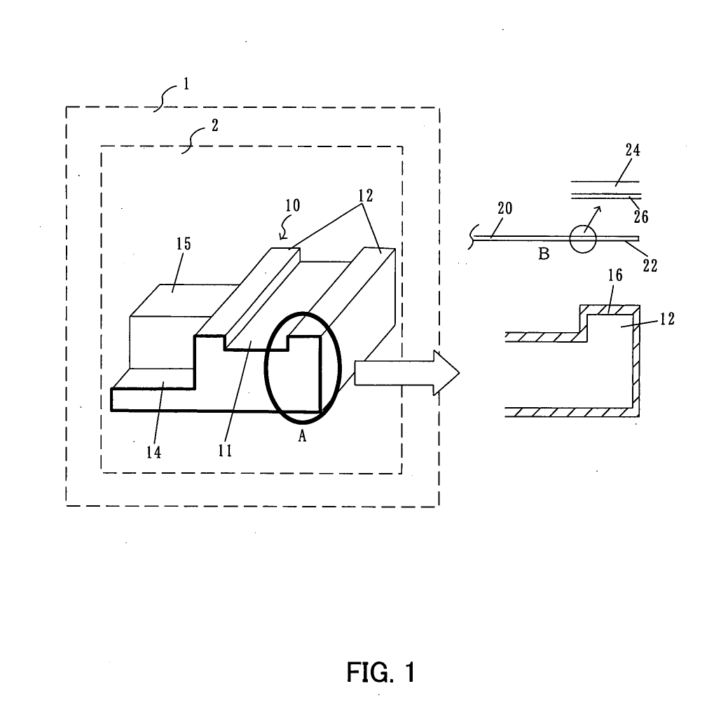

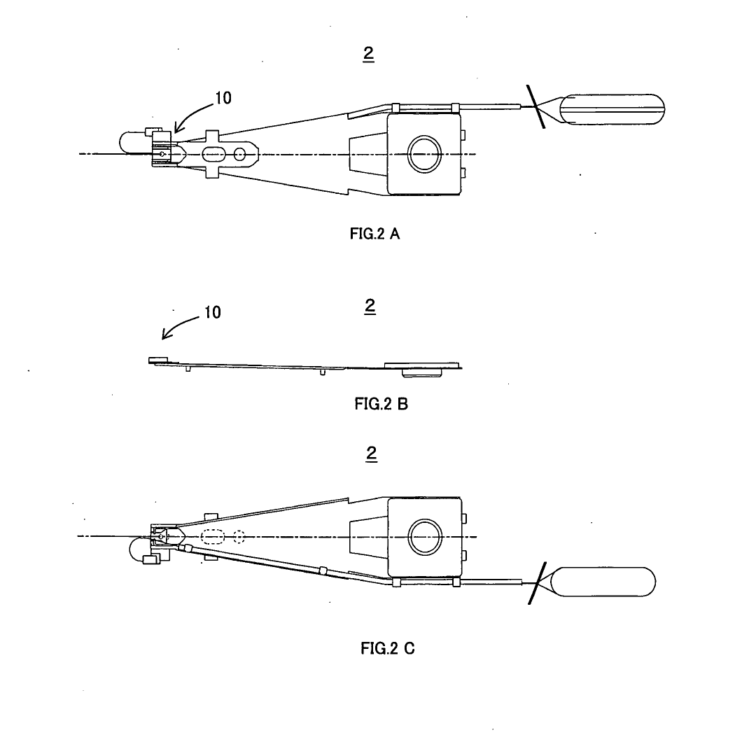

Referring now to FIG. 1, a description will be given of a structure of an inspection head 2 in a glide inspection apparatus (magnetic disk inspecting apparatus) 1. The glide inspection apparatus is an inspection apparatus that inspects whether there is an abnormal projection on a disk surface 22, and includes an inspection head 2 that has a slider 10, in addition to other components (not shown). Here, FIG. 1 (left side) is a schematic perspective view of the slider 10, and FIG. 1 (right side) is an enlarged sectional view of A part of the slider 10 shown in FIG. 1 (left side). In addition, B part of a disk 20 in FIG. 1 (right side) is enlarged at the top of it. An inspection head 2 having a slider 10 is shown in FIGS. 2A-2C. FIG. 2A is a schematic plane view of the inspection head 2. FIG. 2B is a schematic side view of the inspection head 2. FIG. 2C is a schematic rear view of the inspection head 2.

The slider 10 is made of Al₂O₃—TiC (altic) with an approximately rectangular parallelepiped shape, has no recording/reproducing head, and floats over the disk surface 22 of a magnetic disk 20. When the slider 10 is not made of altic, diamond like carbon (DLC) is preferably coated. The slider 10 includes a floating surface 11, a side wing 14, and a lubrication layer 16.

The floating surface 11 is a medium opposing surface that opposes to the disk 20. The airflow generated by rotations of the disk 20 is received by the floating surface 11. A pair of rails 12 is formed on the floating surface 11 and extends from the air inflow end to the air outflow end. Each rail 12's top surface serves as an air bearing surface (“ABS”), which forms a floating force in accordance with the airflow action.

The side wing 14 is a mount part mounted with a piezoelectric sensor 15, which is used for an inspection by the glide inspection apparatus 1.

The lubrication layer 16 is repellent to a lubrication layer 26 on the disk surface 22 and covers the floating surface 11. The disk 20 has, for example, a base layer 24 and the lubrication layer 26. The base layer 24 includes, in order from a non-magnetic substrate, for example, a primary coat layer containing Cr, an intermediate layer, a magnetic layer as a recording layer made of a CoCr alloy material and a protective layer. The lubrication layer 26 is made of a polymer material, such as tetraol.

The lubrication layer 16 is made of a perfluoroeter compound that dispenses with a hydroxyl group on a distal end, such as Z25 fomblin. In this embodiment, the lubrication layer 16 covers the entire slider 10 as shown in FIG. 1 (right side), but it is enough for the lubrication layer 16 to cover at least the ABS surface. The lubrication layer 16 makes the surface of the slider 10 less likely to absorb contaminants, and even when the slider 10 adheres to the disk surface 22, the lubrication layer 16 facilitates a separation between them.

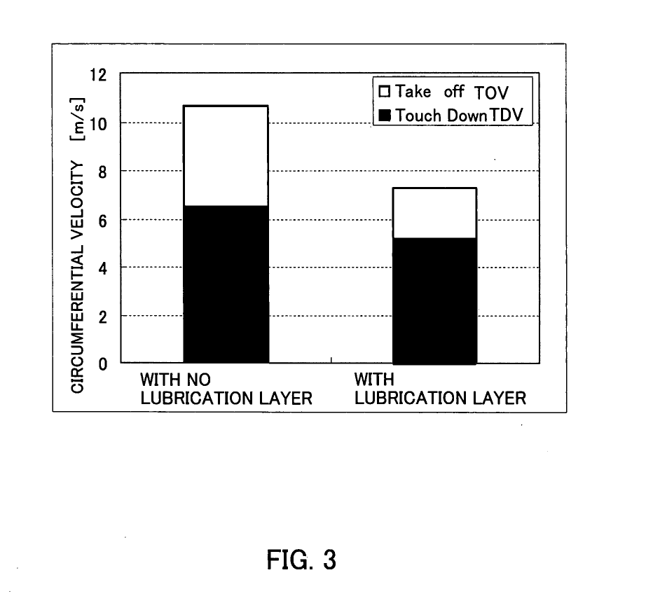

Referring now to FIGS. 3 to 5C, a description will be given of an effect of the lubrication layer 16. FIG. 3 is a graph showing a relationship between a take off velocity (“TOV”) and a touch down velocity (“TDV”) of the slider shown in FIG. 1 and a conventional slider. The TDV is a circumferential speed of the disk for the slider when the floating slider drops on and collides with the disk surface 22. The TOV is a circumferential speed of the disk for the slider when the slider takes off from the disk surface 22 and starts floating.

The conventional slider has a TDV of 6.5 m/s and a TOV of 10.8 m/s, whereas the slider 10 has a TDV of 5.2 m/s and a TOV of 7.4 m/s. The glide inspection apparatus 1 is configured to provide a constant circumferential speed from the inner circumference to the outer circumference on the disk 20, and does not have means for changing the circumferential speed. When the circumferential speed is too large, a floating amount of the slider 10 is too high to detect an abnormal projection on the disk surface 22. When the circumferential speed is about 8 m/s, for example, and the slider adheres to the disk surface 22 for some reasons, the conventional slider cannot take off again since the circumferential speed is smaller than its TOV. On the other hand, the slider 10 can again take off since the circumferential speed is greater than its TDV. Thus, the slider 10 can preferably take off with a smaller circumferential speed than the conventional slider.

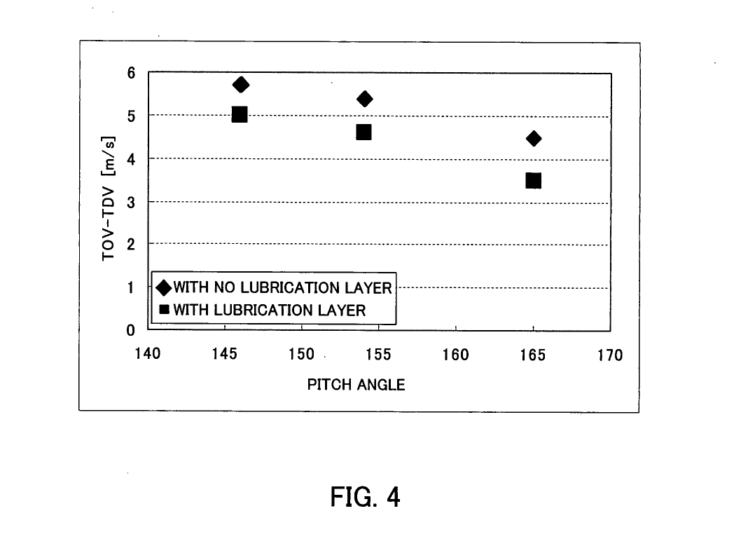

FIG. 4 is a graph showing a relationship between the pitch angle and TOV-TDV of each of the conventional slider with no lubrication layer 16 and the slider 10 of this embodiment. Prior art prevents an absorption of the slider by modifying a pitch angle: As the pitch angle increases, the slider's floating surface is close to a perpendicular to the disk surface and is subject to wind. Therefore, due to a high pitch angle, the slider is likely to separate from the disk surface even when the slider adhere to the disk surface 22. However, an excessively high pitch angle disadvantageously makes the slider subject to vibrations due to the influence of wind. It is understood from FIG. 4 that TOV-TDV (m/s) is small for a certain pitch-angle range. For example, the slider 10 preferably reduces the pitch angle down to about 155° for a value of TOV-TDV (m/s) which corresponds to the pitch angle of 165° in the conventional slider.

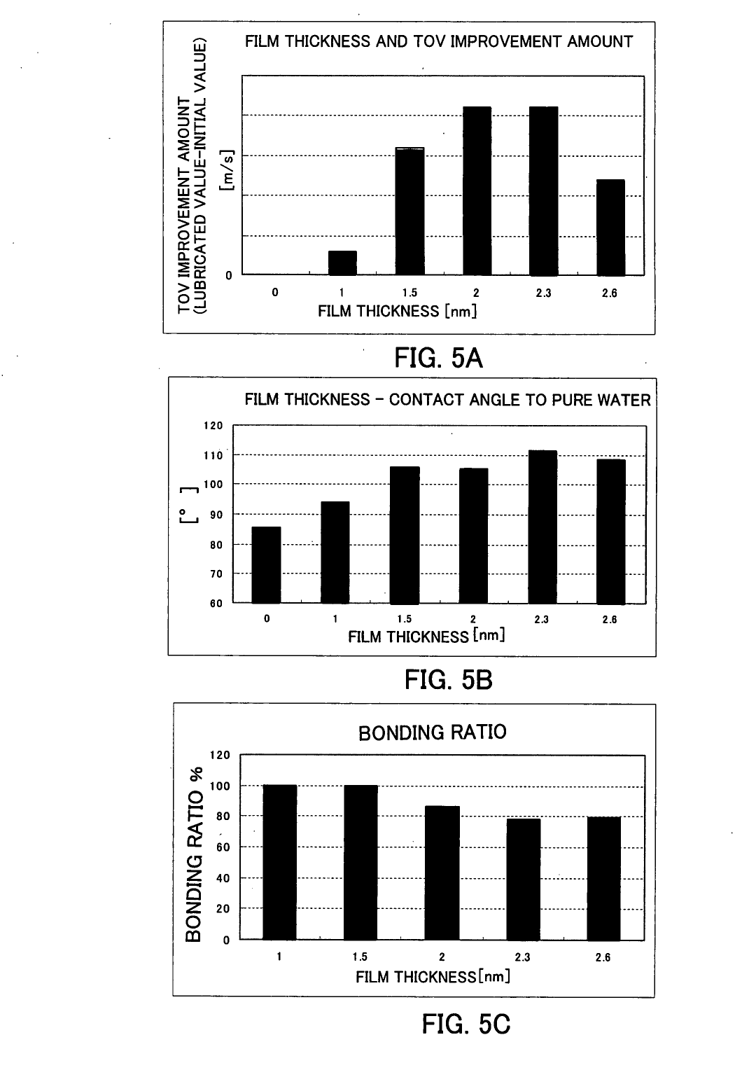

FIG. 5A is a graph showing a relationship between a film thickness of the lubrication layer 16 and the TOV improvement amount. It is understood that the TOV amount remarkably improves in a film-thickness range between 1.5 nm and 2.6 nm. FIG. 5B is a graph showing a relationship between a film thickness of the lubrication layer 16 and a contact angle to pure water. The contact angle to pure water of 100° or greater can be secured in a film-thickness range between 1.5 nm and 2.6 nm. FIG. 5C is a graph showing a relationship between a film thickness of the lubrication layer 16 and an bonding ratio with the surface of the slider 10. A sufficient bonding ratio is secured in a film-thickness range between 1.0 nm and 2.6 nm. FIG. 5C is a graph that shows an amount of the lubrication layer 16 remaining on the slider 10 in a step of baking or irradiating ultraviolet (“UV”) after a step of forming the lubrication layer 16. Thus, a preferable range of the film thickness of the lubrication layer 16 between 1.5 nm and 2.6 nm.

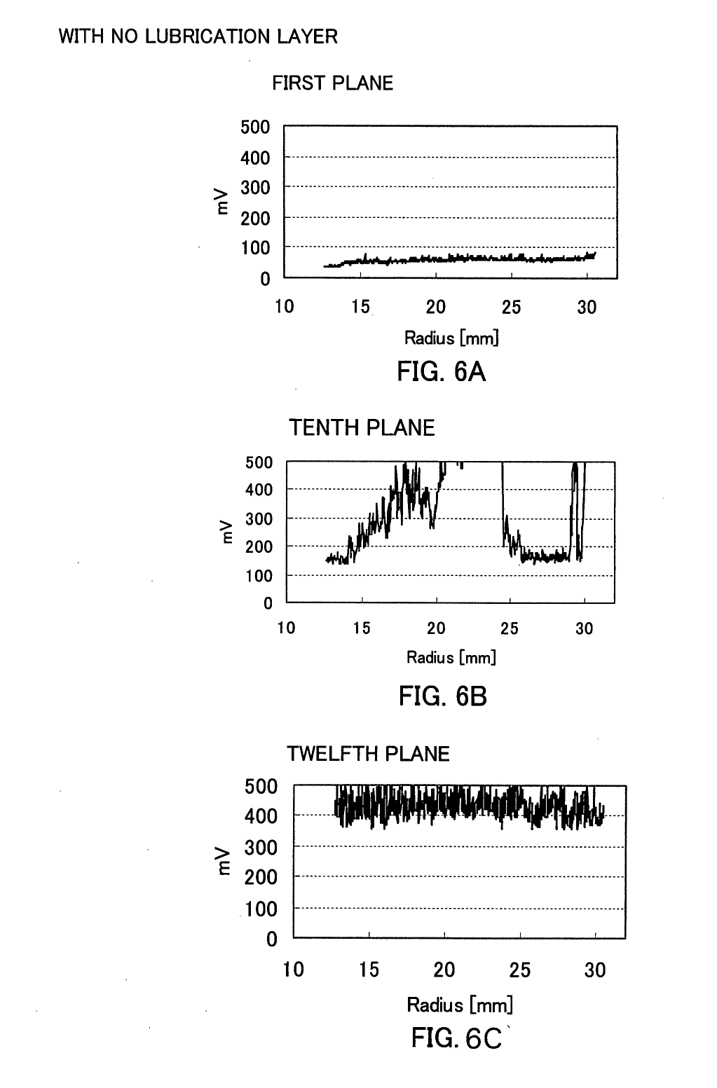

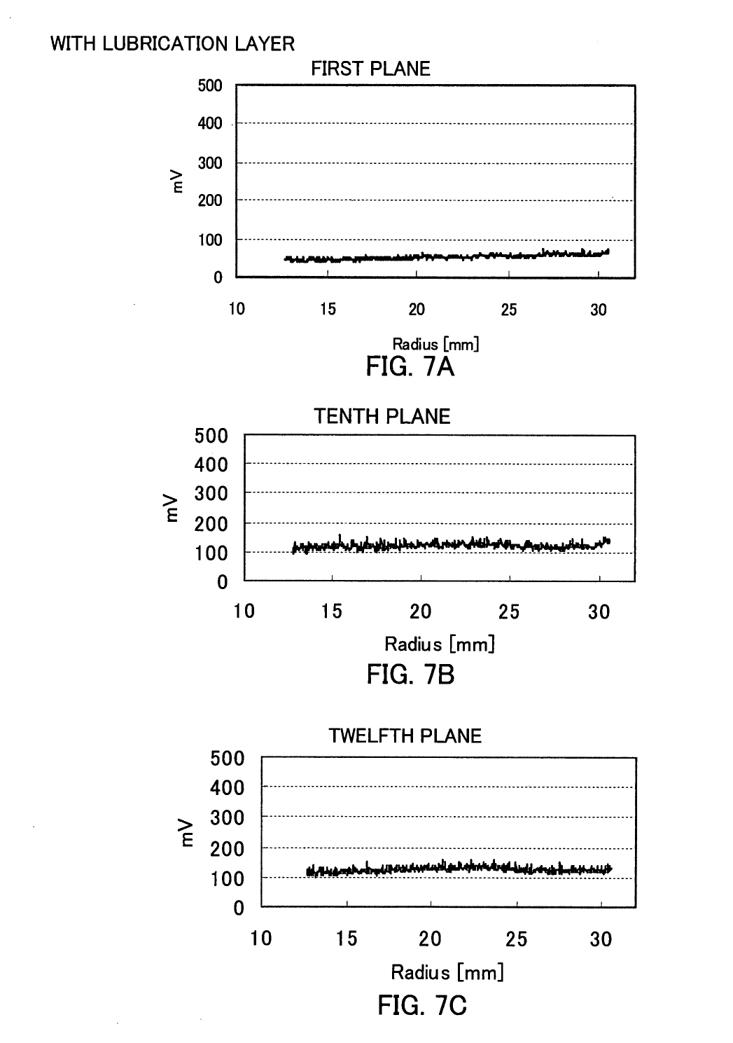

FIGS. 6A to 6C are inspection results of the glide inspection apparatus 1 that uses the conventional slider with no lubrication layer 16. FIGS. 7A to 7C are inspection results of the glide inspection apparatus 1 that uses the slider 10 shown in FIG. 1 that has the lubrication layer 16. First to twelfth disks each of which has no abnormal projection on the disk surface 22 are prepared. In these figures, the abscissa axis denotes a slider position from the center of the disk 20, and the ordinate axis denotes an output of the piezoelectric sensor 15.

As shown in FIGS. 6A and 7A, in inspecting the first disk, the piezoelectric sensor 15 can detect an abnormal projection whichever slider of the detection head 2 is used. The waveform shown in FIGS. 6A and 7A is referred to as a base noise. When the base noise level reaches a certain threshold, the abnormal projection becomes undetectable.

Thereafter, both sliders intermittently collide with the disk surface 22, but the lubrication layer 26 is unlikely to stick to the slider 10. As shown in FIG. 6B, in inspecting the tenth disk, part of the lubrication layer 26 sticks to the conventional slider and the slider becomes likely to collide with the disk surface 22. As a result, the base noise level becomes significantly large, and an output of the piezoelectric sensor 15 becomes unstable relative to a position and partially exceeds a threshold. Therefore, the head having the conventional slider is highly likely to be exchanged. In inspecting the twelfth disk, the base noise level of the conventional slider completely exceeds the threshold, and the slider should be exchanged.

On the other hand, as shown in FIGS. 7B and 7C, in inspecting both the tenth and twelfth disks, the slider 10's base noise level is so stable, low, and durable that the exchange frequency lowers. Thus, the slider of this embodiment improves the inspection throughput since the exchange frequency lowers.

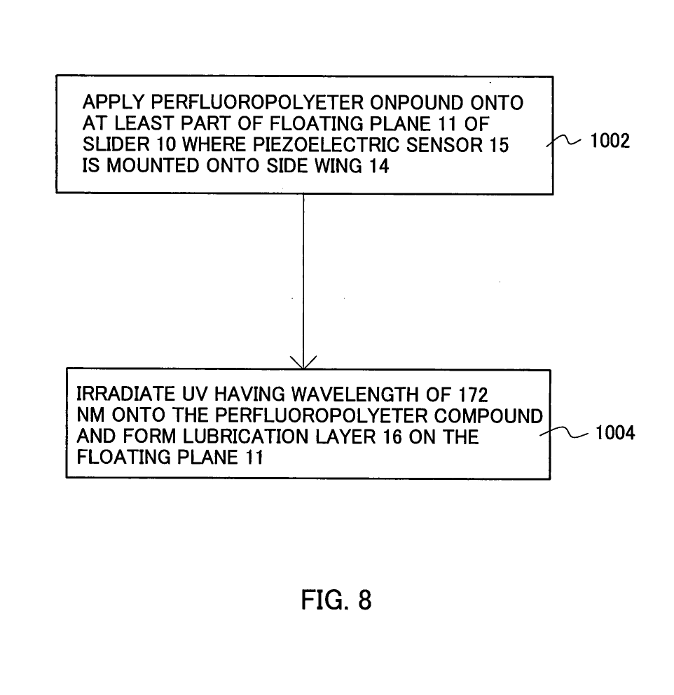

The manufacturing method of the slider 10 includes, as shown in FIG. 8, the step 1002 of applying, onto the floating surface 11 of the slider 10 where the piezoelectric sensor 15 is mounted on the side wing 14, a lubricant of the lubrication layer 16 that is repellent to the lubrication layer 26. Next, the manufacturing method further includes the step 1004 of irradiating the UV light having a wavelength of 172 nm onto the material to form the lubrication layer 16 on the floating surface 11. The UV irradiation can solidify the lubrication layer 16 without baking the entire slider. Therefore, the lubrication layer 16 can be formed without thermally damaging the piezoelectric sensor 15 through burning.

As discussed, the present invention can provide an inspection head to which a contaminant is less likely to adhere.

Further, the present invention is not limited to these preferred embodiments, and various modifications and variations may be made without departing from the spirit and scope of the present invention.

What is claimed is:

1. An inspection head used for an inspecting apparatus that inspects whether there is an abnormal projection on a disk surface having a first lubrication layer, and the inspection head floating over the disk surface, said inspection head comprising a floating surface covered with a second lubrication layer that is repellent to the first lubrication layer.

2. An inspecting apparatus comprising that inspects whether there is an abnormal projection on a disk surface having a first lubrication layer, said inspecting apparatus comprising an inspection head that is configured to float over the disk surface, and the inspection head including a floating surface covered with a second lubrication layer that is repellent to the first lubrication layer.

3. A manufacturing method for manufacturing an inspection head used for an inspecting apparatus that inspects whether there is an abnormal projection on a disk surface having a first lubrication layer, and the inspection head floating over the disk surface, said manufacturing method comprising the steps of:
applying onto a floating surface of the inspection head a lubricant of a second lubrication layer that is repellent to the first lubrication layer; and
irradiating ultraviolet light onto the lubricant and forming the second lubrication layer on the floating surface.

4. A manufacturing method according to claim 3, wherein the lubricant is made of a perfluoropolyether compound that dispenses with a hydroxyl group at a distal end.

5. A manufacturing method according to claim 3, wherein said forming step sets a film thickness of the second lubrication layer between 1.5 nm and 2.6 nm.
